(19) United States
(12) Patent Application Publication
(10) Pub. No.: US 2026/0287792 A1
(43) Pub. Date: Sep. 24, 2026

(54) ANTIREFLECTIVE MEMBER, POLARIZING PLATE, PANEL, IMAGE DISPLAY DEVICE, AND ANTIREFLECTIVE ARTICLE WHICH USE THE ANTIREFLECTIVE MEMBER, AND METHOD FOR SELECTING ANTIREFLECTIVE MEMBER

(71) Applicant: DAI NIPPON PRINTING CO., LTD., Tokyo (JP)

(72) Inventors: Kazuya HONDA, Okayama-shi, Okayama (JP); Jun SATO, Okayama-shi, Okayama (JP); Kana HORII, Okayama-shi, Okayama (JP); Kenichi ONODERA, Okayama-shi, Okayama (JP); Hiroto TAKASE, Okayama-shi, Okayama (JP); Asaka OKANO, Okayama-shi, Okayama (JP)

(21) Appl. No.: 19/475,254

(22) PCT Filed: Apr. 17, 2024
(86) PCT No.: PCT/JP2024/015240

§ 371 Date: Dec. 10, 2025

(30) Foreign Application Priority Data
Apr. 19, 2023 (JP) 2023-068472

(51) Int. Cl. G02B 1/115

(52) U.S. Cl. CPC G02B 1/115

(57) ABSTRACT

Provided is an antireflective member having good scratch resistance. An antireflective member having a low refractive index layer on a substrate, wherein: the low refractive index layer contains a binder component, hollow particles, and solid particles; the low refractive index layer contains, as the solid particles, solid particles α having a particle size larger than an average particle size of the hollow particles; and in an image of a perpendicular cross-section of the antireflective member taken with a scanning transmission electron microscope, an average of numbers of the solid particles α per μm in a width direction of the low refractive index layer is 0.7 or more and 8.0 or less.

### TECHNICAL FIELD

The present disclosure relates to an antireflective member, and a polarizing plate, a panel, an image display device, and an antireflective article in which the antireflective member is used, as well as a method for selecting an antireflective member.

### BACKGROUND ART

There are some cases where antireflective members are provided on surfaces in, for example, display devices such as liquid crystal display devices, organic EL display devices and micro LED display devices, and showcases, for the purpose of an improvement in visibility.

As antireflective members, those having a low refractive index layer on a substrate have been proposed. The low refractive index layer contains, for example, hollow particles for lowering the refractive index and a binder component for retaining the hollow particles. As antireflective members in which the low refractive index layer contains hollow particles, for example, PTLs 1 to 2 have been proposed. The low refractive index layer in PTL 1 contains solid particles.

### CITATION LIST

### Patent Literature

PTL1: JP 2020-30363 A
PTL2: JP 2022-150906 A

### SUMMARY OF INVENTION

### Technical Problem

Antireflective members are disposed on the surface of members such as an image display device for use. Thus, the surface of the antireflective members is abraded during operation of a touch panel, wiping of dirt, and the like. Therefore, the antireflective members are required to have excellent scratch resistance. In addition, foldable image display devices are increasing in recent years. These foldable image display devices are also required to have excellent scratch resistance. Further, since the image display devices have become ultrafine in recent years, scratches generated on the antireflective member tend to be conspicuous. Thus, the antireflective members have been required to have scratch resistance beyond that of the conventional antireflective members.

However, the conventional antireflective members such as the antireflective members in PTLs 1 and 2 have insufficient scratch resistance.

An object of the present disclosure is to provide an antireflective member having good scratch resistance, as well as a polarizing plate, a panel, an image display device, and an antireflective article using the same. Another object of the present disclosure is to provide a method for efficiently selecting an antireflective member that has good scratch resistance.

### Solution to Problem

The present disclosure provides the following <1> to <6>.
<1> An antireflective member comprising a low refractive index layer on a substrate, wherein
   the low refractive index layer comprises a binder component, hollow particles, and solid particles,
   the low refractive index layer comprises, as the solid particles, solid particles α having a particle size larger than an average particle size of the hollow particles, and
   in an image of a perpendicular cross-section of the antireflective member taken with a scanning transmission electron microscope, an average of numbers of the solid particles α per μm in a width direction of the low refractive index layer is 0.7 or more and 8.0 or less.
<2> A polarizing plate comprising a polarizer, a first transparent protective plate disposed on one side of the polarizer, and a second transparent protective plate disposed on the other side of the polarizer, wherein any one of the first transparent protective plate and the second transparent protective plate is the antireflective member according to <1>, and the antireflective member is disposed such that a surface thereof on the low refractive index layer side faces the opposite side to the polarizer.
<3> An image display panel comprising a display element and an optical film disposed on a light-emitting surface side of the display element, wherein the image display panel comprises the antireflective member according to <1> as the optical film, the antireflective member is disposed such that a surface thereof on the low refractive index layer side faces the opposite side to the display element, and the antireflective member is disposed on an outermost surface.
<4> An image display device comprising the panel according to <3>, the antireflective member being disposed on an outermost surface.
<5> An antireflective article, wherein the antireflective member according to <1> is disposed on a member such that a surface thereof on the low refractive index layer side faces the opposite side to the member, and the antireflective member is disposed on an outermost surface.
<6> A method for selecting an antireflective member, the method comprising
   determining whether or not the following (1) to (4) are satisfied, and selecting one that satisfies the following (1) to (4):
(1) the antireflective member has a low refractive index layer on a substrate;
(2) the low refractive index layer comprises a binder component, hollow particles, and solid particles;
(3) the low refractive index layer comprises, as the solid particles, solid particles α having a particle size larger than an average particle size of the hollow particles; and
(4) in an image of a perpendicular cross-section of the antireflective member taken with a scanning transmission electron microscope, an average of numbers of the solid particles α per μm in a width direction of the low refractive index layer is 0.7 or more and 8.0 or less.

### Advantageous Effects of Invention

The antireflective member of the present disclosure, as well as a polarizing plate, an image display device, and an antireflective article using the same can improve scratch resistance. The method for selecting an antireflective member of the present disclosure can efficiently select an antireflective member that has good scratch resistance.

### BRIEF DESCRIPTION OF DRAWINGS

FIG. 1 is a schematic cross-sectional view showing one embodiment of an antireflective member of the present disclosure.

FIG. 2 is a cross-sectional view showing one embodiment of a panel of the present disclosure.

### DESCRIPTION OF EMBODIMENTS

Embodiments of the present disclosure will be described below.

### [Antireflective Member]

An antireflective member of the present disclosure is an antireflective member having a low refractive index layer on a substrate, wherein
the low refractive index layer contains a binder component, hollow particles, and solid particles,
the low refractive index layer contains, as the solid particles, solid particles α having a particle size larger than an average particle size of the hollow particles, and
in an image of a perpendicular cross-section of the antireflective member taken with a scanning transmission electron microscope, an average of numbers of the solid particles α per μm in a width direction of the low refractive index layer is 0.7 or more and 8.0 or less.

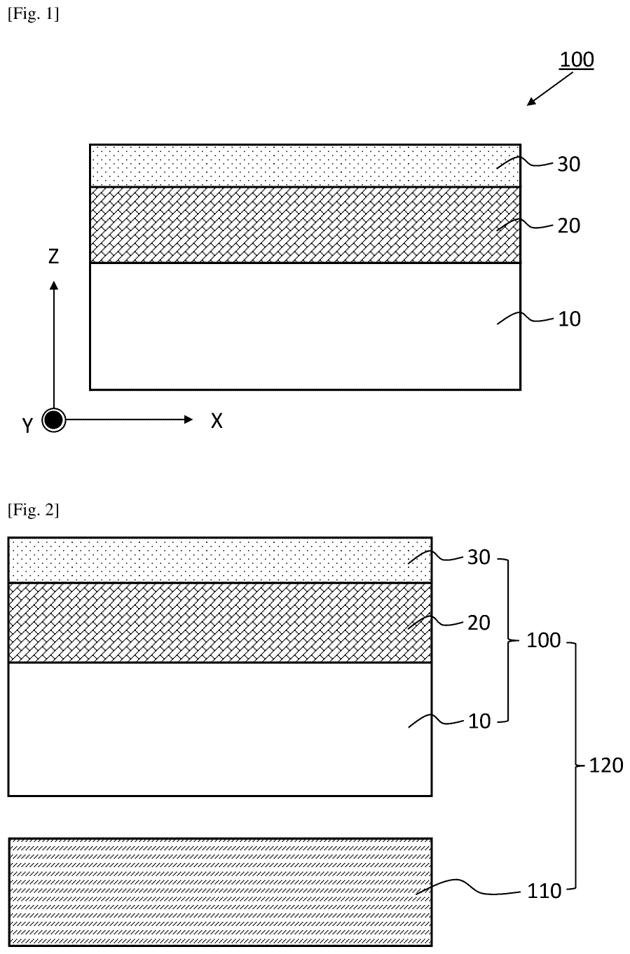

FIG. 1 is a schematic cross-sectional view of a cross-sectional shape of an antireflective member 100 of the present disclosure.

The antireflective member 100 of FIG. 1 has a low refractive index layer 30 on a substrate 10. The antireflective member 100 of FIG. 1 has a hardcoat layer 20 between the substrate 10 and the low refractive index layer 30.

FIG. 1 is a schematic cross-sectional view. That is, the scale of each layer constituting the antireflective member 100 and the scale of each material are schematic for ease of illustration, and thus are different from the actual scale and the like. The same applies to FIG. 2.

In the present specification, the “width direction of the low refractive index layer” means a “direction perpendicular to the thickness direction of the low refractive index layer”. The Z direction in FIG. 1 corresponds to the thickness direction of the low refractive index layer.

In the present specification, the “average of numbers of the solid particles α per μm in a width direction of the low refractive index layer” may be abbreviated to an “average of numbers of the solid particles α”.

The antireflective member of the present disclosure is not limited to the laminated structure shown in FIG. 1. For example, the antireflective member of the present disclosure may have the low refractive index layer directly on the substrate. The antireflective member of the present disclosure may also have other layers not shown in FIG. 1.

Examples of preferred embodiments of the laminated structure of the antireflective member of the present disclosure include “a laminated structure having a hardcoat layer and a low refractive index layer on a substrate in the order presented” and “a laminated structure having a hardcoat layer, a high refractive index layer, and a low refractive index layer on a substrate in the order presented”.

### <Substrate>

The substrate preferably has optical transmitting properties, smoothness, heat resistance, and excellent mechanical strength. Examples of such a substrate include plastic films such as polyester, triacetyl cellulose (TAC), cellulose diacetate, cellulose acetate butyrate, polyamide, polyimide, polyether sulfone, polysulfone, polypropylene, polymethylpentene, polyvinyl chloride, polyvinyl acetal, polyether ketone, polymethyl methacrylate, polycarbonate, polyurethane, and amorphous olefin (Cyclo-Olefin-Polymer: COP). The substrate may be a laminate of two or more plastic films.

Among the above, a polyester film such as polyethylene terephthalate and polyethylene naphthalate is preferable from the viewpoints of mechanical strength and dimensional stability. Among polyester films, films subjected to a stretching process are preferable, and films subjected to a biaxial stretching process are more preferable. TAC and acrylic are preferable from the viewpoint of optical transmittance and optical isotropy. COP and polyester are preferable in terms of excellent weather resistance.

The thickness of the substrate is preferably 5 μm or more and 300 μm or less, more preferably 20 μm or more and 200 μm or less, and still more preferably 30 μm or more and 120 μm or less.

When it is desired to reduce the thickness of the antireflective member, the upper limit of the thickness of the substrate is preferably 80 μm or less, and more preferably 70 μm or less.

The thickness of the substrate is measured with a contact-type film thickness measurement device. Examples of the contact-type film thickness measurement device include a model number “MDC-25SX” available from MITUTOYO CORPORATION. In the present specification, the thickness of the substrate means an average value of measurement values at 10 locations.

Examples of the preferred range of the thickness of the substrate include 5 μm or more and 300 μm or less, 5 μm or more and 200 μm or less, 5 μm or more and 120 μm or less, 5 μm or more and 80 μm or less, 5 μm or more and 70 μm or less, 5 μm or more and 20 μm or less, 20 μm or more and 300 μm or less, 20 μm or more and 200 μm or less, 20 μm or more and 120 μm or less, 20 μm or more and 80 μm or less, 20 μm or more and 70 μm or less, 30 μm or more and 300 μm or less, 30 μm or more and 200 μm or less, 30 μm or more and 120 μm or less, 30 μm or more and 80 μm or less, 30 μm or more and 70 μm or less.

In order to improve adhesiveness, the surface of the substrate may be subjected to a physical treatment such as a corona discharge treatment or a chemical treatment, or an easily adhesive layer may be formed on the surface of the substrate.

The substrate preferably has a total light transmittance of 70% or more, more preferably 80% or more, and still more preferably 85% or more, in accordance with JIS K7361-1:1997.

### <Low Refractive Index Layer>

The low refractive index layer is preferably located on the surface of the antireflective member.

The low refractive index layer is required to contain a binder component, hollow particles, and solid particles.

Further, the low refractive index layer is required to contain, as the solid particles, solid particles α having a particle size larger than an average particle size of the hollow particles, and in an image of a perpendicular cross-section of the antireflective member taken with a scanning transmission electron microscope, an average of numbers of the solid particles α per μm in a width direction of the low refractive index layer is required to 0.7 or more and 8.0 or less.

<<Average of Numbers of Solid Particles α>>

Hereinafter, the method for measuring the average of the numbers of the solid particles α will be described, as well as the technical significance of the number of the solid particles α.

### —Method for Measuring Average of Numbers of Solid Particles α—

The average of the numbers of the solid particles α is measured according to the following procedure of step 1 to step 3.

Step 1: An image of a perpendicular cross-section of the antireflective member is taken with a scanning transmission electron microscope.

In the present specification, the “perpendicular cross-section of the antireflective member” means, when the surface of the antireflective member is assumed as the XY plane, a cross-section perpendicular to the XY plane.

In the step 1, an acceleration voltage of the scanning transmission electron microscope (STEM) is regulated within a range of 0.5 kV or higher and 30 kV or lower, and an emission current is regulated within a range of 1 uA or higher and 20 uA or lower.

In the step 1, the image of the perpendicular cross-section of the antireflective member is taken by preparing a sectioned sample with the perpendicular cross-section of the antireflective member exposed, and using the sample.

Step 2: From the image taken in the step 1, the number of solid particles having a particle size larger than an average particle size of the hollow particles is counted. The counted number of the particles is divided by 2.54 μm, which is a width of the image, to calculate the number of the solid particles α per μm in the width direction of the low refractive index layer.

In the image taken in the step 1, the solid particles are observed in an entirely painted state in blackish deep color. That is, in the image taken in the step 1, the particles painted in the deep color correspond to the solid particles.

In the step 2, the number of solid particles having a particle size larger than the average particle size of the hollow particles is counted. In the step 2, the number of solid particles having a particle size of smaller than or equal to the average particle size of the hollow particles, among the solid particles, is not counted. Thus, the average particle size of the hollow particles needs to be calculated before the step 2. A method for calculating the average particle size of the hollow particles will be described later.

In the step 2, the particle size of each solid particle means a maximum diameter of each solid particle.

In the step 2, the maximum diameter of each solid particle means the linear distance in a combination of two straight lines such that the linear distance between the two straight lines is maximum when the cross-section of the solid particle is sandwiched between two arbitrary parallel straight lines. The maximum diameter of the particle size of each solid particle is calculated based on the image taken in the step 1.

Step 3: By the steps 1 to 2, a “number of the solid particles α per μm in the width direction in the low refractive index layer” is calculated in arbitrary one measurement region of the antireflective member. Further, the steps 1 to 2 are carried out at other nine locations in the antireflective member to calculate the numbers at the ten locations in total. An average of numbers at eight locations excluding the maximum value and the minimum value among the numbers at the ten locations is defined as the “average of the numbers of the solid particles α per μm in the width direction in the low refractive index layer” of the present disclosure. The ten measurement locations are randomly selected from locations without visual abnormal points such as dust and scratches.

### —Technical Significance of Number of Solid Particles α—

The solid particles α are solid particles having a particle size larger than the average particle size of the hollow particles. In the conventional antireflective members, the particle size of the solid particles is commonly set to be smaller than or equal to the average particle size of the hollow particles in order to lower a refractive index of the low refractive index layer. However, the hollow particles have poor strength compared with the solid particles. The solid particles having a small particle size have not sufficiently compensated for the insufficient strength of the hollow particles. Thus, in the present disclosure, the solid particles α having a particle size larger than the average particle size of the hollow particles are added as the solid particles in the low refractive index layer.

However, investigation by the present inventors have found that merely adding the solid particles α in the low refractive index layer cannot improve scratch resistance of the antireflective member.

First, when the average of the numbers of the solid particles α is too large, unevenness on the surface of the low refractive index layer becomes large, or binding ability of the particles such as the solid particles and the hollow particles to the binder component deteriorates. In case where unevenness of the surface of the low refractive index layer becomes large, when the surface of the low refractive index layer is abraded with an abrasive matter such as cloth, the abrasive matter tends to catch on the enlarged unevenness on the surface of the low refractive index layer, which consequently tends to apply a load near the unevenness. As a result, defects and scratches tend to be generated near the uneven portion. When the binding ability of the particles to the binder component deteriorates, the particles tends to fall out, which consequently tends to generate defects and scratches due to the abrasion. Thus, when the average of the numbers of the solid particles α is too large, the scratch resistance cannot be improved. In addition, when the average of the numbers of the solid particles α is too large, the bending resistance deteriorates, which causes difficulty in application for the foldable image display device.

Second, when the average of the numbers of the solid particles α is too small, the load applied to the hollow particles with low strength cannot be suppressed, and thus, the scratch resistance cannot be improved. When the average of the numbers of the solid particles α is too small, the abrasion resistance against soft matters such as a finger and cloth specifically tends to deteriorate. The foldable image display device has a hinge at the folding part. The hinge may be disposed such that an entirety or a part thereof is exposed to the surface of the foldable image display device. The hinge comes into contact with the antireflective member in a state of near point contact (meanwhile, a finger and cloth come into contact with the antireflective member in surface contact). Thus, in order to inhibit scratching on the antireflective member against the hinge, a predetermined number or more of the solid particles α are preferably contained within a width as narrow as 1 μm.

The present inventors have made intensive investigation, and consequently found that scratch resistance can be improved by setting the average of the numbers of the solid particles α per μm in the width direction in the low refractive index layer to 0.7 or more and 8.0 or less.

The lower limit of the average of the numbers of the solid particles α is preferably 0.8 or more, and more preferably 1.0 or more, and the upper limit thereof is preferably 7.0 or less, and more preferably 5.0 or less.

Examples of the preferred range of the average of the numbers of the solid particles α include 0.7 or more and 8.0 or less, 0.7 or more and 7.0 or less, 0.7 or more and 5.0 or less, 0.8 or more and 8.0 or less, 0.8 or more and 7.0 or less, 0.8 or more and 5.0 or less, 1.0 or more and 8.0 or less, 1.0 or more and 7.0 or less, and 1.0 or more and 5.0 or less.

The average of the numbers of the solid particles α can be regulated by a content rate of the solid particles α and dispersion of the solid particles α

In order to make it easier to exhibit the effect by the solid particles α, a standard deviation a of the numbers of the solid particles α is preferably 0.31 or more and 0.80 or less, more preferably 0.35 or more and 0.60 or less, and further preferably 0.40 or more and 0.55 or less.

The standard deviation a means a value calculated from the numbers at the eight locations excluding the maximum value and the minimum value among the ten locations in the steps 1 to 4. A smaller standard deviation a means less variation of the numbers of the solid particles α at the measurement locations.

In the present specification, the measurement of the average of the numbers of the solid particles α, and other measurements of surface roughness, haze, and the like shall be carried out at a temperature of 23±5° C. and a relative humidity of 40% or more and 65% or less, unless otherwise noted. Before starting each measurement, the measurement is performed after exposing the target sample to the atmosphere for 30 minutes or more and 60 minutes or less.

### <<Hollow Particles>>

The low refractive index layer of the present disclosure is required to contain hollow particles.

The hollow particles refer to particles which each have an outer shell layer, have a hollow thereinside, surrounded by the outer shell layer, and include air in the hollow. The hollow particles are particles which have a lowered refractive index proportional to the porosity.

The material of the outer shell layer of the hollow particles may be an inorganic compound such as silica, magnesium fluoride, or an organic compound, but silica is preferable from the viewpoint of lowering the refractive index and strength. That is, the low refractive index layer preferably contains hollow silica particles as hollow particles.

In order to make it easy to lower the refractive index of the low refractive index layer, the average particle size of the hollow particles is preferably 40 nm or more, more preferably 45 nm or more, and further preferably 50 nm or more. In order to make it easy to improve the scratch resistance, the average particle size of the hollow particles is preferably 100 nm or less, more preferably 90 nm or less, and further preferably 80 nm or less.

Examples of the preferred range of the average particle size of the hollow particles include 40 nm or more and 100 nm or less, 40 nm or more and 90 nm or less, 40 nm or more and 80 nm or less, 45 nm or more and 100 nm or less, 45 nm or more and 90 nm or less, 45 nm or more and 80 nm or less, 50 nm or more and 100 nm or less, 50 nm or more and 90 nm or less, and 50 nm or more and 80 nm or less.

The average particle size of the hollow particles is calculated according to the following operations B1 to B3.
B1: In the ten measurement regions in the above steps 1 to 3, five hollow particles are extracted from each of the measurement regions to extract 50 hollow particles in total. In the image taken in the step 1, the hollow particles are observed in a state where only an outer shell part of the particle has blackish deep color and the inside has thinner color than the outer shell part. Therefore, particles in which the outer shell part observed in blackish deep color covers an entire periphery of the inside having thinner color are extracted as the hollow particles. In this operation, only entirely imaged particles are the extraction target. As noted above, particles partially cut off on the edge of the image and particles not entirely imaged due to overlap of particles with each other are excluded from the extraction target even though these particles are observed with outer shell part in deep color and inside in thin color.
B2: From the image, the particle size of each hollow particle is calculated. The particle size of each individual hollow particle is the linear distance in a combination of two straight lines such that the linear distance between the two straight lines is maximum when the cross-section of the hollow particle is sandwiched between two arbitrary parallel straight lines.
B3: An average of the particle sizes of the 50 hollow particles is defined as the average particle size of the hollow particles of the present disclosure.

The lower limit of the porosity of the hollow particles is preferably 5% or more, more preferably 10% or more, and still more preferably 20% or more from the viewpoint of lowering the refractive index, and the upper limit is preferably 80% or less, more preferably 70% or less, and still more preferably 60% or less from the viewpoint of strength.

The porosity of the hollow particle is calculated by the following C1 to C3.
C1: Performing SEM observation on the cross-section of the hollow particles, thereby measuring the diameter and the thickness of the outer shell portion excluding the void portion.
C2: Calculating the volume of the void portion of the hollow particles and the volume of the hollow particles when there is no void portion, assuming that the hollow particles are sphere.
C3: Calculating the porosity according to the formula: {(volume of void portion of the hollow particles)/(volume of the hollow particles when there is no void portion)}×100. An average of the porosities of the 50 hollow particles is defined as the porosity of the hollow particles of the present specification.

Examples of the preferred range of the porosity of the hollow particles include 5% or more and 80% or less, 5% or more and 70% or less, 5% or more and 60% or less, 10% or more and 80% or less, 10% or more and 70% or less, 10% or more and 60% or less, 20% or more and 80% or less, 20% or more and 70% or less, and 20% or more and 60% or less.

A larger content rate of the hollow particles more lowers a refractive index of the low refractive index layer. Meanwhile, when the content rate of the hollow particles is too large, the scratch resistance tends to deteriorate.

Thus, the content rate of the hollow particles is preferably 3 mass % or more and 40 mass % or less, more preferably 4 mass % or more and 30 mass % or less, and further preferably 5 mass % or more and 20 mass % or less, based on the total solid content of the low refractive index layer.

Other examples of the preferred range of the content rate of the hollow particles based on the total solid content of the low refractive index layer include 3 mass % or more and 30 mass % or less, 3 mass % or more and 20 mass % or less, 4 mass % or more and 40 mass % or less, 4 mass % or more and 20 mass % or less, 5 mass % or more and 40 mass % or less, and 5 mass % or more and 30 mass % or less.

The particles such as the hollow particles, the solid particles α, and the solid particles β preferably have surfaces coated with a silane coupling agent. The silane coupling agent preferably has a (meth)acryloyl group or an epoxy group, and more preferably has a methacryloyl group.

By subjecting the particles to a surface treatment with a silane coupling agent, the affinity between the particles and the binder component is improved, and excessive aggregation of the particles can be easily suppressed. For this reason, by subjecting the solid particles α to a surface treatment with a silane coupling agent, the average of the numbers of the solid particles α can be easily set to the above range.

### <<Solid Particles α>

The low refractive index layer is required to contain the solid particles α having a particle size larger than the average particle size of the hollow particles.

The material of the solid particles α is preferably inorganic compounds such as silica and magnesium fluoride, and more preferably silica. That is, the solid particles α are preferably solid silica particles.

In order to improve the scratch resistance, the average particle size of the solid particles α is preferably 50 nm or more, more preferably 55 nm or more, and further preferably 60 nm or more. In order to make it easier to lower the refractive index of the low refractive index layer and to improve the scratch resistance, the average particle size of the solid particles α is preferably 150 nm or less, more preferably 130 nm or less, and further preferably 110 nm or less.

Examples of the preferred range of the average particle size of the solid particles α include 50 nm or more and 150 nm or less, 50 nm or more and 130 nm or less, 50 nm or more and 110 nm or less, 55 nm or more and 150 nm or less, 55 nm or more and 130 nm or less, 55 nm or more and 110 nm or less, 60 nm or more and 150 nm or less, 60 nm or more and 130 nm or less, and 60 nm or more and 110 nm or less.

In the present specification, the average particle size of the solid particles α means an average value of the particle sizes of the particles extracted as the solid particles α in the above steps 1 to 3. In calculating the average particle size of the solid particles α, only entirely imaged particles are the extraction target. Particles partially cut off on the edge of the image or particles not entirely imaged due to overlap of particles with each other are excluded from the extraction target.

When the average particle size of the hollow particles is defined as D1 and the average particle size of the solid particles α is defined as D2, D2/D1 is preferably more than 1.0 and 3.8 or less, more preferably 1.1 or more and 3.2 or less, and further preferably 1.2 or more and 2.5 or less. By setting D2/D1 to the aforementioned range, scratch resistance can be more easily improved.

Other examples of the preferred range of D2/D1 include more than 1.0 and 3.2 or less, more than 1.0 and 2.5 or less, 1.1 or more and 3.8 or less, 1.1 or more and 2.5 or less, 1.2 or more and 3.8 or less, and 1.2 or more and 3.2 or less.

Increasing the content rate of the solid particles α can make it easy to improve the scratch resistance. For this reason, the content rate of the solid particles α is preferably 10.0 mass % or more, more preferably 15.0 mass % or more, and further preferably 20.0 mass % or more, based on the total solid content of the low refractive index layer.

Meanwhile, when the content rate of the solid particles α is too large, it is difficult to lower the refractive index of the low refractive index layer, and it is difficult to improve the scratch resistance. For this reason, the content rate of the solid particles α is preferably 50.0 mass % or less, more preferably 45.5 mass % or less, and further preferably 40.0 mass % or less, based on the total solid content of the low refractive index layer.

Examples of the preferred range of the content rate of the solid particles α based on the total solid content of the low refractive index layer include 10.0 mass % or more and 50.0 mass % or less, 10.0 mass % or more and 45.5 mass % or less, 10.0 mass % or more and 40.0 mass % or less, 15.0 mass % or more and 50.0 mass % or less, 15.0 mass % or more and 45.5 mass % or less, 15.0 mass % or more and 40.0 mass % or less, 20.0 mass % or more and 50.0 mass % or less, 20.0 mass % or more and 45.5 mass % or less, and 20.0 mass % or more and 40.0 mass % or less.

### <<Solid Particles β>>

The low refractive index layer preferably further contains, as the solid particles, solid particles β having a particle size smaller than the average particle size of the hollow particles. The inclusion of the solid particles β can make it easier to improve the scratch resistance.

The solid particles β are preferably at least one type of solid particles selected from solid silica particles, solid alumina particles, solid titania particles, and solid zirconia particles. Among the above, the low refractive index layer preferably contains the solid silica particles, and preferably contains the solid silica particles and the solid alumina particles.

In order to make it easier to improve the scratch resistance, the average particle size of the solid particles β is preferably 5 nm or more, more preferably 7 nm or more, and further preferably 10 nm or more. In order to make it easier to lower the refractive index of the low refractive index layer, the average particle size of the solid particles β is preferably 50 nm or less, more preferably 45 nm or less, and further preferably 40 nm or less.

Examples of the preferred range of the average particle size of the solid particles β include 5 nm or more and 50 nm or less, 5 nm or more and 45 nm or less, 5 nm or more and 40 nm or less, 7 nm or more and 50 nm or less, 7 nm or more and 45 nm or less, 7 nm or more and 40 nm or less, 10 nm or more and 50 nm or less, 10 nm or more and 45 nm or less, and 10 nm or more and 40 nm or less.

The average particle size of the solid particles β is calculated according to the following operations D1 to D3.
D1: A cross-section of the antireflective member is imaged with an SEM. The acceleration voltage of the SEM is regulated within a range of 10 kV or higher and 30 kV or lower, and the magnification is regulated within a range of 50,000 times or more and 300,000 times or less.
D2: Any 10 solid particles β are extracted from the observed image, and the particle size of each solid particle p is calculated. The particle size is measured as the linear distance in a combination of two straight lines such that the linear distance between the two straight lines is maximum when the cross-section of the solid particle p is sandwiched between two arbitrary parallel straight lines. In this operation, only entirely imaged particles are the extraction target. Particles partially cut off on the edge of the image and particles not entirely imaged due to overlap of particles with each other are excluded from the extraction target.
D3: The same operations are carried out five times on an observation image of another screen of the same sample, and a value obtained from the number average of the particle sizes of 50 particles in total is defined as the average particle size of the solid particles β.

Increasing the content rate of the solid particles β can make it easy to improve the scratch resistance. Meanwhile, when the content rate of the solid particles β is too large, it is difficult to lower the refractive index of the low refractive index layer, and it is difficult to increase the number of the solid particles α

For this reason, the content rate of the solid particles β is preferably 5.0 mass % or less and 40.0 mass % or less, more preferably 10.0 mass % or more and 30.0 mass % or less, and further preferably 15.0 mass % or more and 20.0 mass % or less, based on the total solid content of the low refractive index layer.

Other examples of the preferred range of the content rate of the solid particles β based on the total solid content of the low refractive index layer include 5.0 mass % or more and 30.0 mass % or less, 5.0 mass % or more and 20.0 mass % or less, 10.0 mass % or more and 40.0 mass % or less, 10.0 mass % or more and 20.0 mass % or less, 15.0 mass % or more and 40.0 mass % or less, and 15.0 mass % or more and 30.0 mass % or less.

The lower limit of the refractive index of the low refractive index layer is preferably 1.10 or more, more preferably 1.20 or more, more preferably 1.26 or more, more preferably 1.28 or more, and more preferably 1.30 or more, and the upper limit thereof is preferably 1.48 or less, more preferably 1.45 or less, more preferably 1.40 or less, more preferably 1.38 or less, and more preferably 1.35 or less.

In the present specification, the refractive indices of the low refractive index layer and the high refractive index layer mean values at the wavelength of 589.3 nm.

Examples of the preferred range of the refractive index of the low refractive index layer include 1.10 or more and 1.48 or less, 1.10 or more and 1.45 or less, 1.10 or more and 1.40 or less, 1.10 or more and 1.38 or less, 1.10 or more and 1.35 or less, 1.20 or more and 1.48 or less, 1.20 or more and 1.45 or less, 1.20 or more and 1.40 or less, 1.20 or more and 1.38 or less, 1.20 or more and 1.35 or less, 1.26 or more and 1.48 or less, 1.26 or more and 1.45 or less, 1.26 or more and 1.40 or less, 1.26 or more and 1.38 or less, 1.26 or more and 1.35 or less, 1.28 or more and 1.48 or less, 1.28 or more and 1.45 or less, 1.28 or more and 1.40 or less, 1.28 or more and 1.38 or less, 1.28 or more and 1.35 or less, 1.30 or more and 1.48 or less, 1.30 or more and 1.45 or less, 1.30 or more and 1.40 or less, 1.30 or more and 1.38 or less, and 1.30 or more and 1.35 or less.

### <<Binder Component>>

The binder component is a component that allows the low refractive index layer to be formed as a layer and also serves as a binding agent to retain the hollow particles.

The low refractive index layer preferably contains a cured product of a curable resin composition as the binder component. The curable resin composition is a composition containing a curable compound such as a thermosetting resin or an ionizing radiation-curable compound.

The ratio of the cured product of the curable resin composition based on the total binder component in the low refractive index layer is preferably 50% by mass or more, more preferably 70% by mass or more, more preferably 90% by mass or more, and most preferably 100% by mass.

Examples of the curable resin composition for the low refractive index layer include thermosetting resin compositions and ionizing radiation-curable resin compositions, and ionizing radiation-curable resin compositions are preferred. That is, the low refractive index layer preferably contains a cured product of an ionizing radiation-curable resin composition as the binder component.

The thermosetting resin composition is a composition containing at least a thermosetting resin, and is a resin composition that is cured by heating.

Examples of thermosetting resins include acrylic resins, urethane resins, phenol resins, urea melamine resins, epoxy resins, unsaturated polyester resins, and silicone resins. If necessary, a curing agent is added to these curable resins in the thermosetting resin composition.

The ionizing radiation-curable resin composition is a composition containing a compound having an ionizing radiation-curable functional group (hereinafter also referred to as an “ionizing radiation-curable compound”). The ionizing radiation refers to electromagnetic waves or charged particle rays that have energy quanta capable of polymerizing or crosslinking molecules, and usually ultraviolet (UV) rays or electron beams (EB) are used, but other electromagnetic waves such as X rays and y rays and charged particle rays such as a rays and ion beams can also be used. Examples of the ionizing radiation-curable functional group include ethylenically unsaturated bond groups such as a (meth)acryloyl group, a vinyl group, an allyl group, an epoxy group, and an oxetanyl group. The ionizing radiation-curable compound preferably has two or more ionizing radiation-curable functional groups.

The ionizing radiation-curable compound is preferably a compound having an ethylenically unsaturated bond group, and in particular, a (meth)acrylate-based compound having a (meth)acryloyl group is more preferable. Both monomers and oligomers can be used as the (meth)acrylate-based compound. The (meth)acrylate-based compound is preferably a polyfunctional (meth)acrylate-based compound. In the present specification, the polyfunctional (meth)acrylate-based compound means a compound having 2 or more (meth)acryloyl groups.

In the present specification, the “polysilsesquioxane substituted with one or more reactive groups”, as described later, shall be distinguished from the “(meth)acrylate-based compound”. That is, in the present specification, the “(meth)acrylate-based compound” is a concept that does not include the “polysilsesquioxane substituted with one or more reactive groups”.

The ionizing radiation-curable compound preferably includes a polyfunctional (meth)acrylate-based compound. In other words, the low refractive index layer preferably contains, as the binder component, a cured product of a polyfunctional (meth)acrylate-based compound.

The polyfunctional (meth)acrylate-based compound may be any of a monomer and an oligomer, but preferably includes a monomer. This is because the monomer uniformly arranges the particles such as the solid particles α easily compared to the oligomer.

Examples of the polyfunctional (meth)acrylate monomer include pentaerythritol tri(meth)acrylate, pentaerythritol tetra(meth)acrylate, dipentaerythritol hexa(meth)acrylate, dipentaerythritol penta(meth)acrylate, 1,6-hexanediol di(meth)acrylate, and neopentyl glycol di(meth)acrylate.

The ionizing radiation-curable compound can be used alone, or in combination of two or more.

In the case where the ionizing radiation-curable compound is an ultraviolet ray-curable compound, the coating solution for a low refractive index layer preferably contains an additive such as a photopolymerization initiator and a photopolymerization accelerator.

Examples of the photopolymerization initiator include at least one selected from acetophenone, benzophenone, α-hydroxyalkylphenone, Michler's ketone, benzoin, benzildimethylketal, benzoyl benzoate, α-acyloxime ester, α-aminoalkylphenone, and a thioxanthone compound.

The photopolymerization accelerator may enhance the curing rate through the reduction of polymerization inhibition due to the air on curing, and examples thereof include at least one selected from isoamyl p-dimethylaminobenzoate and ethyl p-dimethylaminobenzoate.

Preferred examples of the curable compound further include polysilsesquioxane. That is, the low refractive index layer preferably contains, as the binder component, a cured product of polysilsesquioxane.

By containing, as the binder component, a cured product of polysilsesquioxane, the scratch resistance of the low refractive index layer can be easily made good. Since the cured product of polysilsesquioxane easily improves the toughness of not only the surface of the layer, but also the layer as a whole, it is considered to easily make the scratch resistance of the low refractive index layer good. It is also considered that the cured product of polysilsesquioxane has good adhesion to silica, and thus easily makes the scratch resistance of the low refractive index layer good.

When the content of the polysilsesquioxane is too large, the bending resistance of the antireflective member may deteriorate. For this reason, polysilsesquioxane is preferably used in combination with the polyfunctional (meth)acrylate-based compound. That is, the binder component preferably includes a cured product of a polyfunctional (meth)acrylate-based compound and a cured product of polysilsesquioxane.

The mass ratio between the polyfunctional (meth)acrylate-based compound and the polysilsesquioxane is preferably 50:50 to 10:90, more preferably 40:60 to 15:85, and still more preferably 35:65 to 20:80. By setting the content within the aforementioned range, the scratch resistance can be easily made good while inhibiting deterioration in the bending resistance.

The polysilsesquioxane is a polymer having a structural unit represented by the following general formula (1). In the formula (1), R represents an organic group. Examples of the organic group include organic groups having a reactive group, which will be described later. The number of the following structural units is preferably 4 or more and 30 or less.

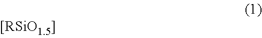

Examples of the structure of the polysilsesquioxane include a random structure, a ladder structure, and a cage structure. Among these, a cage structure is preferable.

In the polysilsesquioxane, at least one or more silicon atoms in the structural units are preferably substituted with reactive groups. When the polysilsesquioxane is substituted with one or more reactive groups, it reacts more easily with the leveling agent described later, thus making it easier to fix the leveling agent in the low refractive index layer. For this reason, the polysilsesquioxane substituted with one or more reactive groups can easily improve scratch resistance and other properties over a long period of time. In addition, the polysilsesquioxane substituted with one or more reactive groups can easily reduce the proportion of siloxane bonds exposed on the surface side of the low refractive index layer, thereby easily improving chemical resistance.

Examples of the reactive groups include a (meth)acryloyl group, a vinyl group, and an epoxy group. Among these, a (meth)acryloyl group is preferable.

More specific examples of the reactive groups include (meth)acrylate, an alkyl (meth)acrylate having 1 or more and 20 or less carbon atoms, a cycloalkyl epoxide having 3 or more and 20 or less carbon atoms, and an alkylcycloalkane epoxide having 1 or more and 10 or less carbon atoms.

The functional group equivalent amount (g/eq) of the reactive groups in the polysilsesquioxane is preferably 50 or more and 1000 or less, and more preferably 100 or more and 500 or less. By setting the functional group equivalent amount to the aforementioned range, polymerization shrinkage of the low refractive index layer can be suppressed, and the leveling agent can be easily fixed in the low refractive index layer, as well.

In the polysilsesquioxane, at least one or more silicon atoms in the structural units may be substituted with reactive groups, and furthermore, at least one or more silicon atoms in the structural units may be further substituted with non-reactive groups. Such a polysilsesquioxane can easily reduce the proportion of siloxane bonds exposed on the surface side of the low refractive index layer, thereby easily improving chemical resistance. In addition, the polysilsesquioxane substituted with non-reactive groups can easily suppress polymerization shrinkage of the low refractive index layer.

Examples of the non-reactive groups include a linear or branched alkyl group having 1 or more and 20 or less carbon atoms, a cyclohexyl group having 6 or more and 20 or less carbon atoms, and an aryl group having 6 or more and 20 or less carbon atoms.

The weight average molecular weight of the polysilsesquioxane is preferably 5000 or less, more preferably 4000 or less, and further preferably 3000 or less, in order to improve the dispersibility of the particle such as the hollow particles and the solid particles α The weight average molecular weight of the polysilsesquioxane is preferably 800 or more, more preferably 900 or more, and still more preferably 1000 or more, in order to increase bonding strength and storage modulus.

### <<Leveling Agent>>

The low refractive index layer preferably contains a leveling agent. When the low refractive index layer contains a leveling agent, the surface has good smoothness, thus making it easy to improve the scratch resistance. In order to make it easier to achieve the aforementioned effect, the leveling agent is preferably a leveling agent having a reactive group. Examples of the reactive groups include a (meth)acryloyl group, a vinyl group, and an epoxy group. Among these, a (meth)acryloyl group is preferable.

Examples of the leveling agent include a silicone leveling agent and a fluorine leveling agent. The silicone leveling agent may contain a small amount of fluorine atoms. The fluorine leveling agent may contain a small amount of silicone atoms.

As noted above, the leveling agent can improve the smoothness of the low refractive index layer surface, but when the content rate is too large, strength of the coating film may decrease to deteriorate the scratch resistance. For this reason, the content rate of the leveling agent is preferably 5.0 mass % or more and 50.0 mass % or less, more preferably 10.0 mass % or more and 40.0 mass % or less, and further preferably 15.0 mass % or more and 30.0 mass % or less, based on the total solid content of the low refractive index layer.

Other examples of the preferred range of the content rate of the leveling agent based on the total solid content of the low refractive index layer include 5.0 mass % or more and 40.0 mass % or less, 5.0 mass % or more and 30.0 mass % or less, 10.0 mass % or more and 50.0 mass % or less, 10.0 mass % or more and 30.0 mass % or less, 15.0 mass % or more and 50.0 mass % or less, and 15.0 mass % or more and 40.0 mass % or less.

The low refractive index layer may further contain additives such as an anti-static agent, an antioxidant, a surfactant, a dispersant, a photostabilizer, and an ultraviolet absorber.

The lower limit of the thickness T of the low refractive index layer is preferably 60 nm or more, more preferably 75 nm or more, and more preferably 90 nm or more, and the upper limit thereof is 150 nm or less, more preferably 115 nm or less, and more preferably 105 nm or less.

Examples of the preferred range of the thickness T of the low refractive index layer include 60 nm or more and 150 nm or less, 60 nm or more and 115 nm or less, 60 nm or more and 105 nm or less, 75 nm or more and 150 nm or less, 75 nm or more and 115 nm or less, 75 nm or more and 105 nm or less, 90 nm or more and 150 nm or less, 90 nm or more and 115 nm or less, and 90 nm or more and 105 nm or less.

In the present specification, the thicknesses of the low refractive index layer, the high refractive index layer, and the hardcoat layer are determined by selecting 20 arbitrary locations in a cross-sectional image of the antireflective member taken with a scanning transmission electron microscope and calculating the average value of the thicknesses of the 20 locations.

When the thickness of the low refractive index layer is defined as T and the average particle size of the hollow particles is defined as D1, D1/T is preferably 0.2 or more and 1.7 or less, more preferably 0.4 or more and 1.2 or less, and further preferably 0.5 or more and 0.9 or less.

By setting D1/T to 0.2 or more, the refractive index of the low refractive index layer can be lowered easily. By setting D1/T to 1.7 or less, scratch resistance can be easily made good.

Other examples of the preferred range of D1/T include 0.2 or more and 1.2 or less, 0.2 or more and 0.9 or less, 0.4 or more and 1.7 or less, 0.4 or more and 0.9 or less, 0.5 or more and 1.7 or less, and 0.5 or more and 1.2 or less.

When the thickness of the low refractive index layer is defined as T and the average particle size of the solid particles α is defined as D2, D2/T is preferably 0.3 or more and 2.5 or less, more preferably 0.5 or more and 1.7 or less, and further preferably 0.6 or more and 1.2 or less.

Other examples of the preferred range of D2/T include 0.3 or more and 1.7 or less, 0.3 or more and 1.2 or less, 0.5 or more and 2.5 or less, 0.5 or more and 1.2 or less, 0.6 or more and 2.5 or less, and 0.6 or more and 1.7 or less.

The low refractive index layer can be formed by applying and drying a coating solution for a low refractive index layer containing components constituting the low refractive index layer and solvents, and curing by irradiation with ionizing radiation as necessary.

### <<Solvent>>

Examples of the solvent include ketones such as acetone, methyl ethyl ketone, methyl isobutyl ketone (MIBK), and cyclohexanone; ethers such as dioxane and tetrahydrofuran; aliphatic hydrocarbons such as hexane; alicyclic hydrocarbons such as cyclohexane; aromatic hydrocarbons such as toluene and xylene; halogenated carbons such as dichloromethane and dichloroethane; esters such as methyl acetate, ethyl acetate, and butyl acetate; alcohols such as isopropanol, butanol, and cyclohexanol; cellosolves such as methyl cellosolve and ethyl cellosolve; glycol ethers such as propylene glycol monomethyl ether acetate; cellosolve acetates; sulfoxides such as dimethyl sulfoxide; amides such as dimethylformamide and dimethylacetamide; and a mixture of these.

### <Functional Layer>

The antireflective member of the present disclosure preferably has at least one functional layer between the substrate and the low refractive index layer. Examples of the functional layer include a hardcoat layer, a high refractive index layer, a conductive layer, and an antistatic layer.

### <<Hardcoat Layer>>

The antireflective member of the present disclosure preferably has a hardcoat layer between the substrate and the low refractive index layer. By having a hardcoat layer, the scratch resistance of the antireflective member can be easily improved.

When the antireflective member further has a high refractive index layer as a functional layer, it preferably has the substrate, the hardcoat layer, the high refractive index layer, and the low refractive index layer in the order presented.

The hardcoat layer preferably contains, as the main component, a cured product of a curable resin composition such as a thermosetting resin composition or an ionizing radiation-curable resin composition, and more preferably contains a cured product of an ionizing radiation-curable resin composition as the main component. The main component means 50% by mass or more, preferably 70% by mass or more, more preferably 90% by mass or more, of the resin component constituting the hardcoat layer.

Examples of the curable resin composition such as a thermosetting resin composition or an ionizing radiation-curable resin composition include those exemplified for the low refractive index layer. The ionizing radiation-curable compound used for the hardcoat layer preferably includes a polyfunctional (meth)acrylate-based compound.

The lower limit of the thickness of the hardcoat layer is preferably 0.5 μm or more, more preferably 1 μm or more, and the upper limit is preferably 30 μm or less, and more preferably 10 μm or less. By setting the thickness of the hardcoat layer within the above range, the occurrence of cracks during processing such as cutting can be easily suppressed while improving the scratch resistance.

Examples of the preferred range of the thickness of the hardcoat layer include 0.5 μm or more and 30 μm or less, 0.5 μm or more and 10 μm or less, 1 μm or more and 30 μm or less, and 1 μm or more and 10 μm or less.

The hardcoat layer may further contain additives such as a leveling agent, an anti-static agent, an antioxidant, a surfactant, a dispersant, a photostabilizer, and an ultraviolet absorber.

### <<High Refractive Index Layer>>

The high refractive index layer can be formed, for example, from a coating solution for a high refractive index layer containing a binder resin composition and high refractive index particles. That is, the high refractive index layer preferably contains a binder component and high refractive index particles.

The high refractive index layer preferably contains a cured product of a curable resin composition as the binder component. The ratio of the cured product of the curable resin composition based on the total binder component in the high refractive index layer is preferably 50% by mass or more, more preferably 70% by mass or more, more preferably 90% by mass or more, and most preferably 100% by mass.

Examples of the curable resin composition for the high refractive index layer include a thermosetting resin composition and an ionizing radiation-curable resin composition, and an ionizing radiation-curable resin composition is preferable. Examples of the curable resin composition such as a thermosetting resin composition or an ionizing radiation-curable resin composition include those exemplified for the low refractive index layer. The ionizing radiation-curable compound used for the high refractive index layer preferably includes a polyfunctional (meth)acrylate-based compound.

Examples of the high refractive index particles include antimony pentoxide, zinc oxide, titanium oxide, cerium oxide, tin-doped indium oxide, antimony-doped tin oxide, yttrium oxide, and zirconium oxide.

The average particle size of the high refractive index particles is preferably 2 nm or more, more preferably 5 nm or more, and still more preferably 10 nm or more. The average particle size of the high refractive index particles is preferably 200 nm or less, more preferably 100 nm or less, more preferably 80 nm or less, more preferably 60 nm or less, and more preferably 30 nm or less, from the viewpoint of suppressing whitening and transparency.

Examples of the preferred range of the average particle size of the high refractive index particles include 2 nm or more and 200 nm or less, 2 nm or more and 100 nm or less, 2 nm or more and 80 nm or less, 2 nm or more and 60 nm or less, 2 nm or more and 30 nm or less, 5 nm or more and 200 nm or less, 5 nm or more and 100 nm or less, 5 nm or more and 80 nm or less, 5 nm or more and 60 nm or less, 5 nm or more and 30 nm or less, 10 nm or more and 200 nm or less, 10 nm or more and 100 nm or less, 10 nm or more and 80 nm or less, 10 nm or more and 60 nm or less, and 10 nm or more and 30 nm or less.

The average particle size of the high refractive particles is calculated according to the following operations E1 to E3.
E1: A cross-section of the antireflective member is imaged with an SEM. The acceleration voltage of the SEM is regulated within a range of 10 kV or higher and 30 kV or lower, and the magnification is regulated within a range of 50,000 times or more and 300,000 times or less.
E2: Any 10 high refractive particles are extracted from the observed image, and the particle size of each high refractive particle is calculated. The particle size is measured as the linear distance in a combination of two straight lines such that the linear distance between the two straight lines is maximum when the cross-section of the high refractive particle is sandwiched between two arbitrary parallel straight lines.
E3: The same operations are carried out five times on an observation image of another screen of the same sample, and a value obtained from the number average of the particle size of 50 particles in total is defined as the average particle size of the high refractive particles.

The lower limit of the content of the high refractive index particles is preferably 100 parts by mass or more, more preferably 150 parts by mass or more, and still more preferably 250 parts by mass or more, and the upper limit thereof is preferably 500 parts by mass or less, more preferably 400 parts by mass or less, and still more preferably 350 parts by mass or less, based on 100 parts by mass of the binder component.

Examples of the preferred range of the content of the high refractive index particle based on 100 parts by mass of the binder component include 100 parts by mass or more and 500 parts by mass or less, 100 parts by mass or more and 400 parts by mass or less, 100 parts by mass or more and 350 parts by mass or less, 150 parts by mass or more and 500 parts by mass or less, 150 parts by mass or more and 400 parts by mass or less, 150 parts by mass or more and 350 parts by mass or less, 250 parts by mass or more and 500 parts by mass or less, 250 parts by mass or more and 400 parts by mass or less, and 250 parts by mass or more and 350 parts by mass or less.

The lower limit of the refractive index of the high refractive index layer is preferably 1.53 or more, more preferably 1.54 or more, more preferably 1.55 or more, more preferably 1.56 or more, and the upper limit thereof is preferably 1.85 or less, more preferably 1.80 or less, more preferably 1.78 or less, more preferably 1.77 or less.

Examples of the preferred range of the refractive index of the high refractive index layer include 1.53 or more and 1.85 or less, 1.53 or more and 1.80 or less, 1.53 or more and 1.78 or less, 1.53 or more and 1.77 or less, 1.54 or more and 1.85 or less, 1.54 or more and 1.80 or less, 1.54 or more and 1.78 or less, 1.54 or more and 1.77 or less, 1.55 or more and 1.85 or less, 1.55 or more and 1.80 or less, 1.55 or more and 1.78 or less, 1.55 or more and 1.77 or less, 1.56 or more and 1.85 or less, 1.56 or more and 1.80 or less, 1.56 or more and 1.78 or less, and 1.56 or more and 1.77 or less.

The upper limit of the thickness of the high refractive index layer is preferably 200 nm or less, more preferably 185 nm or less, still more preferably 175 nm or less, and the lower limit is preferably 50 nm or more, more preferably 70 nm or more.

Examples of the preferred range of the thickness of the high refractive index layer include 50 nm or more and 200 nm or less, 50 nm or more and 185 nm or less, 50 nm or more and 175 nm or less, 70 nm or more and 200 nm or less, 70 nm or more and 185 nm or less, and 70 nm or more and 175 nm or less.

The high refractive index layer may further contain additives such as a leveling agent, an anti-static agent, an antioxidant, a surfactant, a dispersant, a photostabilizer, and an ultraviolet absorber.

### <Surface Shape>

The surface of the antireflective member on the low refractive index layer side preferably has an arithmetic mean roughness Ra of 2.0 nm or more and 15.0 nm or less, more preferably 3.5 nm or more and 14.5 nm or less, and still more preferably 5.0 nm or more and 14.0 nm or less.

When Ra is less than 2.0 nm, the average of the numbers of the solid particles α may be too small. When Ra is more than 15.0 nm, the average of the numbers of the solid particles α may be too large.

Examples of the preferred range of Ra include 2.0 nm or more and 15.0 nm or less, 2.0 nm or more and 14.5 nm or less, 2.0 nm or more and 14.0 nm or less, 3.5 nm or more and 15.0 nm or less, 3.5 nm or more and 14.5 nm or less, 3.5 nm or more and 14.0 nm or less, 5.0 nm or more and 15.0 nm or less, 5.0 nm or more and 14.5 nm or less, and 5.0 nm or more and 14.0 nm or less.

In the present specification, Ra means the average value of the measurement values at 10 locations. In the present specification, Ra is measured in accordance with JIS B0601:2013.

### <Optical Characteristics>

The antireflective member preferably has a total light transmittance of 70% or more, more preferably 80% or more, and still more preferably 85% or more, in accordance with JIS K7361-1:1997.

The light incident surface for measuring total light transmittance and haze, which will be described later, is the opposite side to the surface on the low refractive index layer side.

In the present specification, the total light transmittance, the haze, and the luminous reflectance Y value mean the average value of the measurement values at 10 locations.

The antireflective member preferably has a haze of 1.5% or less, more preferably 1.3% or less, and still more preferably 1.0% or less, in accordance with JIS K7136:2000. By setting the haze to 1.5% or less, the image resolution can be easily improved. The lower limit value of the haze is not particularly limited, but usually, it is preferably 0.1% or more.

Examples of the preferred range of the haze of the antireflective member include 0.1% or more and 1.5% or less, 0.1% or more and 1.3% or less, and 0.1% or more and 1.0% or less.

### <Luminous Reflectance Y Value>

The antireflective member of the present disclosure has a luminous reflectance Y value of preferably 3.0% or less, more preferably 2.5% or less, more preferably 2.0% or less, and more preferably 1.5% or less, the luminous reflectance Y value being measured at an incident angle of light of 5 degrees from the low refractive index layer side.

In the present disclosure, the luminous reflectance Y value is measured by adhering a black plate to the surface of the antireflective member on the substrate side via a transparent adhesive layer to prepare a sample and by causing light incident from the low refractive index layer side of the sample at an incident angle of 5°. The light source condition for calculating the reflectance is a D65 light source.

The difference in refractive index between the member in contact with transparent pressure-sensitive adhesive layer of sample and the transparent pressure-sensitive adhesive layer is 0.15 or less. The difference in refractive index is preferably 0.10 or less, and more preferably 0.05 or less. The member in contact with transparent pressure-sensitive adhesive layer of sample is, for example, the substrate. The black plate has a total light transmittance of 1% or less in accordance with JIS K7361-1:1997. The black plate preferably has a total light transmittance of 0%. The difference in refractive index between the resin constituting the black plate and the refractive index of the transparent adhesive layer is 0.15 or less. The difference in refractive index is preferably 0.10 or less, and more preferably 0.05 or less.

The aforementioned sample is used also in measurement of SCE, described later.

### <SCE>

The antireflective member of the present disclosure has a reflectance measured by an SCE method from the low refractive index layer side of preferably 0.50% or less, more preferably 0.40% or less, more preferably 0.30% or less, and more preferably 0.25% or less.

The SCE is abbreviation of specular component exclude, and is reflected light that is received reflected light excluding a component of specular reflection from the sample.

The SCE is measured by setting the low refractive index layer side of the sample as the light incident surface.

A measurement device of the SCE has a configuration in accordance with the geometric condition c of JIS Z8722:2009.

### <Geometric Condition c of JIS Z8722:2009>

The sample is irradiated evenly from various directions, and reflected light in a direction in which an angle formed with the normal line of the sample surface is 100 or less is received. In this case, the received light flux shall not include light having a tilt of 5° or more relative to its center line. A light trap used for excluding the component of the specular reflection excludes at least 95% of the specular reflected light from the smooth mirror surface.

### <Size, Shape, and the Like>

The antireflective member may be in the form of a single sheet cut into a predetermined size, or may be in the form of a roll obtained by winding a long sheet. The size of the single sheet is not particularly limited, but the maximum diameter is about 2 inches or more and 500 inches or less. The “maximum diameter” means the maximum length of any two points of the antireflective member when connected. For example, when the antireflective member is rectangular, the diagonal line of the rectangle is the maximum diameter. When the antireflective member is circular, the diameter of the circle is the maximum diameter.

The width and length of the roll are not particularly limited, but generally, the width is 500 mm or more and 3000 mm or less and the length is about 50 m or more and 5000 m or less. The antireflective member in the form of a roll may be cut into a single sheet according to the size of an image display device or the like. At the time of cutting, it is preferable to exclude the end portion of the roll where the physical properties are not stable.

The shape of the single sheet is also not particularly limited, and may be, for example, a polygonal shape such as triangular shape, quadrangular shape, pentagonal shape, or a round shape, or may be a randomly irregular shape. More specifically, in a case where the antireflective member has a quadrangular shape, the aspect ratio is not particularly limited as long as it is not problematic in terms of a display screen. For example, the aspect ratio may be horizontal:vertical=1:1, 4:3, 16:10, 16:9, 2:1, or the like.

### [Polarizing Plate]

A polarizing plate of the present disclosure is a polarizing plate having a polarizer, a first transparent protective plate disposed on one side of the polarizer, and a second transparent protective plate disposed on the other side of the polarizer, wherein any one of the first transparent protective plate and the second transparent protective plate is the antireflective member of the present disclosure described above, and the antireflective member is disposed such that the surface of the antireflective member on the low refractive index layer side faces the opposite side to the polarizer.

The polarizing plate is used, for example, for imparting antireflective properties in combination with a λ/4 phase difference plate. In this case, the λ/4 phase difference plate is disposed on the display element of an image display device, and the polarizing plate is disposed on the viewer side to the λ/4 phase difference plate.

In the case where the polarizing plate is for liquid crystal display devices, it is used for imparting functions of the liquid crystal shutter. In this case, in the liquid crystal display device, a lower polarizing plate, a liquid crystal display element, and an upper polarizing plate are disposed in this order from the backlight side, so that the absorption axis of the polarizer of the lower polarizing plate and the absorption axis of the polarizer of the upper polarizing plate are orthogonal to each other. In the configuration of the liquid crystal display device, the polarizing plate of the present disclosure can be used as the upper polarizing plate and the lower polarizing plate, and it is preferable to use the polarizing plate of the present disclosure as the upper polarizing plate. In the upper polarizing plate, it is preferable to use the antireflective member of the present disclosure as the transparent protective plate on the light-emitting surface side of the polarizer. In the lower polarizing plate, it is preferable to use the antireflective member of the present disclosure as the transparent protective plate on the light incident surface side of the polarizer.

### <Transparent Protective Plate>

The polarizing plate of the present disclosure includes the antireflective member of the present disclosure described above, as at least one of the first transparent protective plate and the second transparent protective plate. In a preferred embodiment, both the first transparent protective plate and the second transparent protective plate include the antireflective member of the present disclosure described above.

When one of the first transparent protective plate and the second transparent protective plate includes the antireflective member of the present disclosure, the other transparent protective plate is preferably an optically isotropic transparent protective plate.

In the present specification, the optically isotropy refers to an in-plane phase difference of less than 20 nm, preferably 10 nm or less, more preferably 5 nm or less. Triacetyl cellulose (TAC) films can easily impart optically isotropy.

When one of the first transparent protective plate and the second transparent protective plate includes the antireflective member of the present disclosure, it is preferable that the transparent protective plate on the light-emitting side includes the antireflective member of the present disclosure described above.

### <Polarizer>

Examples of the polarizer include a sheet-type polarizer formed by stretching a film stained with iodine or the like, such as polyvinyl alcohol films, polyvinyl formal films, polyvinyl acetal films, and ethylene-vinyl acetate copolymer saponification films; a wire grid polarizer composed of many metal wires aligned in parallel; a coated polarizer coated with lyotropic liquid crystal and dichroic guest-host material; a multilayer thin film-type polarizer, and the like. Such a polarizer may be a reflective polarizer having a function of reflecting polarization components that do not transmit.

### [Panel]

A panel of the present disclosure is a panel having a display element and an optical film disposed on the light-emitting surface side of the display element, wherein the panel includes the antireflective member of the present disclosure described above as the optical film, the antireflective member is disposed such that the surface thereof on the low refractive index layer side faces the opposite side to the display element, and the antireflective member is disposed on the outermost surface (see FIG. 2).

Examples of display elements include liquid crystal display elements, EL display elements such as organic EL display elements and inorganic EL display elements, plasma display elements, and LED display elements such as micro LED display elements. These display elements may have a touch panel function inside the display element.

Examples of the liquid crystal display method of the liquid crystal display element include an IPS method, a VA method, a multi-domain method, an OCB method, an STN method, and a TSTN method.

The panel of the present disclosure may be a panel with a touch panel having the touch panel between the display element and the antireflective member. In this case, the antireflective member may be disposed on the outermost surface of the image display panel with the touch panel, and the surface of the antireflective member on the low refractive index layer side may be disposed so as to face the side opposite to the display element.

The size of the panel is not particularly limited, but the maximum diameter is about 2 inches or more and 500 inches or less. The maximum diameter refers to the maximum length of any two points within the image display panel when connected.

### [Image Display Device]

An image display device of the present disclosure includes the panel of the present disclosure described above, and the antireflective member is disposed on the outermost surface.

The image display device of the present disclosure preferably further includes a drive control unit electrically connected to the panel and a housing that accommodates the panel, the drive control unit, and others.

When the display element is a liquid crystal display element, the image display device of the present disclosure requires a backlight. The backlight is disposed on the opposite side to the light-emitting surface side of the liquid crystal display element.

The size of the image display device is not particularly limited, but the maximum diameter of the effective display region is about 2 inches or more and 500 inches or less.

The effective display region of an image display device is an area in which an image can be displayed. For example, when the image display device has a housing that surrounds the display element, the region inside the housing becomes the effective display region.

The maximum diameter of the effective display region refers to the maximum length of any two points within the effective display region when connected. For example, when the effective display region is rectangular, the diagonal line of the rectangle is the maximum diameter. When the effective display region is circular, the diameter of the circle is the maximum diameter.

### [Antireflective Article]

The antireflective article of the present disclosure includes the aforementioned antireflective member on a member disposed such that a surface of the antireflective member on the low refractive index layer side is disposed so as to face the opposite side to the member, the antireflective member being disposed on an outermost surface.

The member and the antireflective member are preferably laminated via an adhesive layer.

Examples of the member include an instrument panel, a watch, a showcase, a shop window, and a window. The member may be transparent or non-transparent, and the color tone is also not particularly limited.

### [Method for Selecting Antireflective Member]

The method for selecting an antireflective member of the present disclosure includes determining whether or not the following (1) to (4) are satisfied, and selecting one that satisfies the following (1) to (4):
(1) the antireflective member has a low refractive index layer on a substrate;
(2) the low refractive index layer comprises a binder component, hollow particles, and solid particles;
(3) the low refractive index layer comprises, as the solid particles, solid particles α having a particle size larger than an average particle size of the hollow particles; and
(4) in an image of a perpendicular cross-section of the antireflective member taken with a scanning transmission electron microscope, an average of numbers of the solid particles α per μm in a width direction of the low refractive index layer is 0.7 or more and 8.0 or less.

The method for selecting an antireflective member of the present disclosure can efficiently select an antireflective member having good scratch resistance, by selecting an antireflective member that satisfies the above (1) to (4).

A preferred embodiment of the above (1) to (4) is in accordance with the preferred embodiment of the antireflective member of the present disclosure described above.

With respect to the above (1), for example, “an antireflective member having a substrate, a hardcoat layer, and a low refractive index layer in the order presented” is preferable.

With respect to the above (2), for example, it is preferred to contain, as the binder component, a cured product of polysilsesquioxane.

With respect to the above (3), for example, the solid particles α are preferably solid silica particles.

With respect to the above (4), for example, the average of the numbers of the solid particles α is preferably 0.8 or more and 7.0 or less.

Preferably, the method for selecting an antireflective member of the present disclosure further has an additional determination condition. Examples of the additional determination condition include one or more selected from the group consisting of the preferred embodiments exemplified in the antireflective member of the present disclosure described above.

Specific examples of the additional determination condition include the following (5) to (7). That is, the method for selecting an antireflective member of the present disclosure preferably has one or more selected from the group consisting of the following determination conditions (5) to (7). A preferred embodiment of the following (5) to (7) is in accordance with the preferred embodiment of the antireflective member of the present disclosure described above:
(5) a surface of the antireflective member on the low refractive index layer side has an arithmetic mean roughness Ra of 2.0 nm or more and 15.0 nm or less;
(6) a luminous reflectance Y value is 3.0% or less, as measured at an incident angle of light of 5 degrees from a side of the low refractive index layer; and
(7) an SCE is 0.50% or less, as measured from the low refractive index layer side.

The present disclosure includes the following <1> to <18>.
<1> An antireflective member comprising a low refractive index layer on a substrate, wherein
   the low refractive index layer comprises a binder component, hollow particles, and solid particles,
   the low refractive index layer comprises, as the solid particles, solid particles α having a particle size larger than an average particle size of the hollow particles, and
   in an image of a perpendicular cross-section of the antireflective member taken with a scanning transmission electron microscope, an average of numbers of the solid particles α per μm in a width direction of the low refractive index layer is 0.7 or more and 8.0 or less.
<2> The antireflective member according to <1>, wherein the average particle size of the hollow particles is 40 nm or more and 100 nm or less.
<3> The antireflective member according to <1> or <2>, wherein an average particle size of the solid particles α is 50 nm or more and 150 nm or less.
<4> The antireflective member according to any of <1> to <3>, wherein, when a thickness of the low refractive index layer is defined as T and an average particle size of the hollow particles is defined as D1, D1/T is 0.2 or more and 1.7 or less.
<5> The antireflective member according to any one of <1> to <4>, wherein, when a thickness of the low refractive index layer is defined as T and an average particle size of the solid particles α is defined as D2, D2/T is 0.3 or more and 2.5 or less.
<6> The antireflective member according to any one of <1> to <5>, wherein, when the average particle size of the hollow particles is defined as D1 and the average particle size of the solid particles α is defined as D2, D2/D1 is more than 1.0 and 3.8 or less.
<7> The antireflective member according to any one of <1> to <6>, wherein the hollow particles are hollow silica particles.
<8> The antireflective member according to any one of <1> to <7>, wherein the solid particles α are solid silica particles.
<9> The antireflective member according to any one of <1> to <8>, further comprising, as the solid particles, solid particles β having a particle size smaller than or equal to the average particle size of the hollow particles.
<10> The antireflective member according to <9>, comprising, as the solid particles β, at least one type of solid particles selected from solid silica particles, solid alumina particles, solid titania particles, and solid zirconia particles.
<11> The antireflective member according to any one of <1> to <10>, comprising, as the binder component, a cured product of polysilsesquioxane.
<12> The antireflective member according to any one of <1> to <11>, comprising at least one functional layer between the substrate and the low refractive index layer.
<13> The antireflective member according to <12>, comprising, as the functional layer, a hardcoat layer.
<14> A polarizing plate comprising a polarizer, a first transparent protective plate disposed on one side of the polarizer, and a second transparent protective plate disposed on the other side of the polarizer, wherein any one of the first transparent protective plate and the second transparent protective plate is the antireflective member according to any of <1> to <13>, and the antireflective member is disposed such that a surface thereof on the low refractive index layer side faces the opposite side to the polarizer.
<15> An image display panel comprising a display element and an optical film disposed on a light-emitting surface side of the display element, wherein the image display panel comprises the antireflective member according to any of <1> to <13> as the optical film, the antireflective member is disposed such that a surface thereof on the low refractive index layer side faces the opposite side to the display element, and the antireflective member is disposed on an outermost surface.
<16> An image display device comprising the panel according to <15>, the antireflective member being disposed on an outermost surface.
<17> An antireflective article, wherein the antireflective member according to any of <1> to
<13> is disposed on a member such that a surface thereof on the low refractive index layer side faces the opposite side to the member, and the antireflective member is disposed on an outermost surface.
<18> A method for selecting an antireflective member, the method comprising:
   determining whether or not the following (1) to (4) are satisfied, and selecting one that satisfies the following (1) to (4):
(1) the antireflective member has a low refractive index layer on a substrate;
(2) the low refractive index layer comprises a binder component, hollow particles, and solid particles;
(3) the low refractive index layer comprises, as the solid particles, solid particles α having a particle size larger than an average particle size of the hollow particles; and
(4) in an image of a perpendicular cross-section of the antireflective member taken with a scanning transmission electron microscope, an average of numbers of the solid particles α per μm in a width direction of the low refractive index layer is 0.7 or more and 8.0 or less.

### EXAMPLES

Next, the present disclosure will be described in more detail with reference to Examples, but the present disclosure is not limited by these Examples. “Parts” and “%” are based on mass unless otherwise specified.

### 1. Measurement and Evaluation

The antireflective members of Examples and Comparative Examples were measured and evaluated as follows.

The atmosphere during each measurement and evaluation was set at a temperature of 23±5° C. and a relative humidity of 40% or more and 65% or less unless otherwise specified. Before starting each measurement and evaluation, the target sample was exposed to the atmosphere for 30 minutes or more and 60 minutes or less, and then the measurement and evaluation were performed.

The sample used for each measurement and evaluation are prepared by cutting the antireflective members of Examples and Comparative Examples. The cutting site was selected from random sites after visually confirming that there were no abnormal points such as dust and scratches.

### 1-1. Average of Numbers of Solid Particles α

For the antireflective members of Examples and Comparative Examples, the average of the numbers of the solid particles α was measured. The measurement was carried out according to the steps 1 to 3 in the text of the specification. As the scanning transmission electron microscope used in the step 1, a trade name SU-9000 from Hitachi High-Technologies Corporation was used. In the step 1, the mode was set to “BFSTEM”, the acceleration voltage was set to 30 kV, and the emission current was set to 20 uA. The image was adjusted such that the region not including the scale bar had a size of 2.54 μm in horizontal dimension×1.91 μm in vertical dimension. The region was calculated from DataSize=1280×960 and PixelSize=1.984375 nm.

In the step 1, the sectioned sample with the perpendicular cross-section of the antireflective member exposed was prepared according to the procedure of the following (A1) to (A2).
(A1) The antireflective member was cut to any size to prepare a cut sample, and then the cut sample was embedded with a resin to prepare an embedded sample. The size of the cut sample was a strip form of 10 mm in vertical dimension×3 mm in horizontal dimension. For the resin for embedding, an epoxy resin was used.

The embedded sample was obtained by pouring the resin for embedding into a silicon embedding plate after the cut sample was placed, further leaving the resin to stand at normal temperature for 12 hours to cure the resin for embedding, and then taking out the cut sample and the resin for embedding surrounding it from the silicon embedding plate. The embedded sample was set to have a block shape.

The epoxy resin for embedding used was a 10:1.2 mixture of the trade name “Epofix” from Struers and the trade name “Curing agent for Epofix” from the same company. For the silicon embedding plate, a silicon embedding plate from Dosaka EM Co., Ltd. was used.
(A2) The embedded sample in the form of a block was cut perpendicularly to prepare a sectioned sample with the cross-section of the antireflective member exposed. The embedded sample was cut with a microtome by using a glass knife and a diamond knife.

The microtome used was the trade name “Ultramicrotome EM UC7” from Leica Microsystems. In cutting the embedded sample in the form of a block with the above device, the embedded sample was first roughly cut with the glass knife to prepare a surface of about 100 um in vertical dimension×20 um in horizontal dimension, including the cross-section of the coated surface (rough trimming). This surface was finally cut with the diamond knife under the conditions of “SPEED: 1.40 mm/s” and “FEED: 80 nm”, and the section was floated above water and collected with a mesh. The mesh used was collodion membrane-coated mesh (Cat No; 651) from Nisshin-EM.

### 1-2. Luminous Reflectance Y Value

The antireflective members of Examples and Comparative Examples were cut into 5 cm×5 cm. The substrate side of the cut antireflective member was pasted to a black plate (manufactured by Kuraray Co., Ltd., trade name: Comoglass DFA2CG 502K (black) Series, thickness 2 mm) having a size of vertical 5 cm×horizontal 5 cm through an optically transparent pressure-sensitive adhesive sheet (Panac Co., Ltd., trade name: Panaclean PD-Si) to prepare a sample.

Light was incident on the sample from a direction of 5 degrees when the direction perpendicular to the surface of the sample on the low refractive index layer side was set at 0 degrees, and the luminous reflectance Y value of the sample was measured based on specular reflected light of incident light. The measured luminous reflectance Y value means an initial luminous reflectance Y value.

The measurement device used was a spectral reflectometer (manufactured by Shimadzu Corporation, trade name: UV-2600). The measuring device performs measurement of the reflectance in the range of the wavelength of 380 nm or more and 780 nm or less at an interval of 0.5 nm, and then carries out conversion by means of software that performs conversion into brightness sensed by human eyes. The above software is software built in the measurement device. The software calculates the reflectance under the conditions where the light source is D65 and the viewing angle is 2 degrees.

### 1-3. SCE

By using an integrating sphere spectrometer (manufactured by KONICA MINOLTA, INC., trade name: CM-600d), the reflectance was measured by an SCE method from the low refractive index layer side of the sample prepared in 1-2. The measurement was carried out under conditions in which light source of the integrating sphere spectrometer was D65, a position of a light receiver was +8 degrees relative to the normal line of the sample, an opening angle of the light receiver was 10 degrees, a position of a light trap was −8 degrees relative to the normal line of the sample, and a viewing angle was 2 degrees. The measured reflectance means an initial reflectance.

### 1-4. Total Light Transmittance (Tt) and Haze (Hz)

The antireflective members of Examples and Comparative Examples were cut into 10 cm×10 cm to prepare measurement samples. The total light transmittance in accordance with JIS K7361-1:1997 and the haze in accordance with JIS K7136:2000 of each sample were measured under the following conditions using a haze meter (HM-150, manufactured by Murakami Color Research Laboratory Co., Ltd.). The measured total light transmittance and haze mean initial total light transmittance and haze.

### <Conditions>

In order to stabilize the light source, the power switch of the apparatus was turned on in advance and the apparatus was allowed to stand for 15 minutes or more, and then, calibration was performed without setting anything in the inlet opening where the measurement sample was to be installed. Thereafter, the measurement sample was set at the inlet opening, and the total light transmittance and the haze were measured. The light incident surface during measurement was on the substrate side.

### 1-5. Scratch Resistance 1 (Eraser Resistance)

### (1) Change in Luminous Reflectance Y Value

The surface on the low refractive index layer side of the sample prepared in 1-2 was abraded with an eraser under the following conditions. Then, a luminous reflectance Y value after the abrasion with the eraser was measured. A difference between the initial luminous reflectance Y value and a luminous reflectance Y value after the abrasion with the eraser was calculated as ΔY. ΔY of 1.0% or less was acceptable.

### <Conditions of Eraser Abrasion>

A pencil with an eraser (product name “Stationary Pencil 9852 (with eraser)”, manufactured by MITSUBISHI PENCIL COMPANY, LIMITED) was cut in the middle. The cut pencil with the eraser was inserted from the opposite side to the eraser side into a jig having a hole with 6 mm in diameter such that the eraser was completely exposed. The jig having the pencil with the eraser was attached to a JSPS-type abrasion fastness tester (product name “AB-301”, manufactured by TESTER SANGYO CO., LTD.), and the surface on the low refractive index layer side of the sample was abraded 3000 round trips with a load of 1000 g, an abrasion speed of 30.0 mm/see, and a motion distance per round trip of 30 mm.

### (2) Pure Water Contact Angle

The sample after the abrasion with the eraser of the (1) was used for measuring a pure water contact angle. The pure water contact angle of the surface on the low refractive index layer side of the sample was measured. Specifically, the contact angle was measured in accordance with a sessile drop method described in JIS R3257:1999 by using a microscopic contact angle meter (product name “DropMaster 300”, manufactured by Kyowa Interface Science Co., Ltd.). The pure water contact angle was an average of values at five points. An amount of dropped pure water was 2 μL. A pure water contact angle after the eraser abrasion of 90 degrees or more was acceptable.

Note that the pure water contact angle of the antireflective members of Examples and Comparative Examples before the eraser abrasion were all 110 degrees or more.

### (3) Evaluation

Based on the results of the (1) and the (2), the eraser resistance was evaluated according to the following criteria. It can be said that good eraser resistance indicates good scratch resistance against soft matters such as a finger and cloth.
A: Both ΔY and the pure water contact angle were acceptable. In other words, ΔY was 1.0% or less and the pure water contact angle after the eraser abrasion was 90 degrees or more.
C: One of ΔY and the pure water contact angle was acceptable, but the other was not acceptable.
D: Both ΔY and the pure water contact angle were not acceptable. In other words, ΔY was more than 1.0% and the pure water contact angle after the eraser abrasion was less than 90 degrees.

### 1-6. Scratch Resistance 2 (Steal Wool Resistance)

### <Breaking In>

A polyethylene terephthalate film (thickness 100 μm) was pasted to the measurement stage of a measurement device (product name “AB-301”, manufactured by TESTER SANGYO CO., LTD.). Next, steel wool (#0000, from Nihon Steel Wool Co., Ltd., trade name “Bonstar B-204”) was set. The steel wool was brought into contact with the surface of the polyethylene terephthalate film, and the steel wool was moved back and forth 300 times under the conditions where the load was 500 g, the moving speed was 50 mm/see, and the moving distance per round trip was 80 mm. The contact area between the steel wool and the polyethylene terephthalate film was 4 cm².

### <Final Measurement>

Samples of the antireflective member cut into 3 cm×25 cm were prepared for Examples and Comparative Examples. The cutting site was selected from random sites after visually confirming that there were no abnormal points such as dust and scratches.

One of the samples was installed on the measurement stage of the measurement device with the low refractive index layer side facing up. The steel wool was brought into contact with the surface of the low refractive index layer, and the steel wool was moved back and forth 1000 times under the conditions where the load was 1500 g, the moving speed was 4000 mm/min, and the moving distance per round trip was 80 mm. The contact area between the steel wool and the sample was 4 cm².

Next, under a bright room environment of 500 Lux or more and 1500 Lux or less, the sample was visually checked for the number of scratches with a length of 1 cm or more, and ranked according to the following criteria. Note that, as described above, scratches with a length of less than 1 cm were not counted as scratches. In addition, among the 80 mm moving distance of the steel wool, the moving speed was not constant in the region of 10 mm from each end. For this reason, scratches were not counted for the region of 10 mm from each end among the 80 mm moving distance of the steel wool.
A: the number of scratches was less than 5
B: the number of scratches was 5 or more and less than 15
C: the number of scratches was 15 or more, or peeling occurred on the low refractive index layer even when the number of scratches was less than 15.

### 2. Preparation of Coating Solution

The following coating solutions were prepared as a coating solution for a hardcoat layer, a coating solution for a low refractive index layer, and a coating solution for a high refractive index layer. In the coating solution, “MIBK” and “MEK” mean “methyl isobutyl ketone” and “methyl ethyl ketone”, respectively.

### <Coating Solution for Hardcoat Layer 1>

Urethane acrylate: 17 parts by mass
   (TOKUSHIKI Co., Ltd., trade name “AU-3110”)
Polypropylene glycol acrylate: 3 parts by mass
   (SHIN-NAKAMURA CHEMICAL Co., Ltd., trade name “APG-200”)
Photopolymerization initiator: 1.2 parts by mass
   (IGM Resins B.V., trade name “Omnirad184”)
Silica particles: 40 parts by mass
   (solid content: 30 mass %, solvent: MIBK, average primary particle size: 20 nm)
Leveling agent: 0.03 parts by mass
   (BYK Inc., trade name “BYK-331”)
MIBK: 60 parts by mass

### <Coating Solution for Low Refractive Index Layer 1>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 15 parts by mass
   (solid content: 20 mass %, solvent: MIBK, average primary particle size: 60 nm)
Solid particles α: 22 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for Low Refractive Index Layer 2>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 15 parts by mass
   (solid content: 20 mass %, solvent: MIBK, average particle size: 75 nm)
Solid particles α: 22 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for Low Refractive Index Layer 3>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 28 parts by mass
   (solid content: 20 mass %, solvent: MIBK, average particle size: 60 nm)
Solid particles α: 14 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for Low Refractive Index Layer 4>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 6 parts by mass
   (solid content: 20 mass %, solvent: MIBK, average particle size: 60 nm)
Solid particles α: 27 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass
   <Coating solution for low refractive index layer 5>
Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 15 parts by mass
   (solid content: 20 mass %, solvent: MIBK, average particle size: 60 nm)
Solid particles α: 44 parts by mass
   (solid silica particles, solid content: 20 mass %, solvent: MIBK, average particle size: 100 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass
   <Coating solution for low refractive index layer 6>
Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 37 parts by mass
   (solid content: 20 mass %, solvent: MIBK, average particle size: 60 nm)
Solid particles α: 11 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass
   <Coating solution for low refractive index layer 7>
Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 15 parts by mass
   (solid content: 20 mass %, solvent: MIBK, average particle size: 60 nm)
Solid particles β: 22 parts by mass
   (solid silica particles, solid content: 40 mass %, solvent: MIBK, average particle size: 12 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for Low Refractive Index Layer 8>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 15 parts by mass
   (solid content: 20 mass %, solvent: MIBK, average particle size: 60 nm)
Solid particles β: 29 parts by mass
   (solid silica particles, solid content: 30 mass %, solvent: MIBK, average particle size: 45 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass
   <Coating solution for low refractive index layer 9>
Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 42 parts by mass
   (solid content: 20 mass %, solvent: MIBK, average particle size: 60 nm)
Solid particles α: 7 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for Low Refractive Index Layer 10>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 42 parts by mass
   (solid content: 20 mass %, solvent: MIBK, average particle size: 75 nm)
Solid particles α: 7 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for Low Refractive Index Layer 11>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Hollow silica particles: 52 parts by mass
   (solid content: 20 mass %, solvent: MIBK, average particle size: 60 nm)
Solid particles α: 4 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for Low Refractive Index Layer 12>

Pentaerythritol triacrylate: 2 parts by mass
   (DAICEL-ALLNEX LTD., trade name “PETIA”)
Polysilsesquioxane having methacryloyl group: 6 parts by mass
   (Construe Chemical Co., Ltd., trade name “Mehtacryl polysilsesquioxane cage mixture”)
Photopolymerization initiator: 1 part by mass
   (IGM Resins B.V., trade name “Omnirad184”)
Solid particles α: 50 parts by mass
   (solid silica particles, solid content: 40 mass %, solvent: MIBK, average particle size: 80 nm)
Solid particles β: 10 parts by mass
   (solid silica particles, solid content: 30 mass %, solvent: MIBK, average particle size: 12 nm)
Solid particles β: 8 parts by mass
   (solid alumina particles, solid content: 30 mass %, solvent: MIBK, average particle size: 30 nm)
Leveling agent: 30 parts by mass
   (Shin-Etsu Chemical Co., Ltd., trade name “KY-1211”, solid content: 20 mass %, solvent: MEK)
MIBK: 730 parts by mass

### <Coating Solution for High Refractive Index Layer 1>

Urethane acrylate: 4 parts by mass
   (Kyoeisha Chemical Co., Ltd., trade name “UA-306H”)
Zirconium oxide particles: 70 parts by mass
   (solid content: 70 mass %, solvent: MEK, average particle size: 11 nm)
Photopolymerization initiator: 1 part by mass
   (IGM Resins B.V., trade name “Omnirad184”)
Leveling agent: 0.04 parts by mass
   (BYK Inc., trade name “BYK-331”)
MIBK: 540 parts by mass

### 3. Production of Antireflective Member

### EXAMPLE 1

A coating solution for a hardcoat layer 1 was applied onto a polyethylene terephthalate film having a thickness of 50 μm, and then dried at 70° C. for 1 minute to vaporize the solvent. Subsequently, by ultraviolet irradiation at a cumulative light amount of 50 mJ/cm² in a nitrogen atmosphere with an oxygen concentration of 200 ppm or less, a hardcoat layer having a dry film thickness of 6 μm was formed.

Next, the coating solution for a low refractive index layer 1 was applied onto the hardcoat layer, and then dried at 70° C. for 60 seconds to evaporate the solvent. Subsequently, a low refractive index layer having a dry film thickness of 95 nm was formed by ultraviolet irradiation at a cumulative light amount of 400 mJ/cm² in a nitrogen atmosphere with an oxygen concentration of 200 ppm or less whereby the antireflective member of Example 1 was obtained.

### EXAMPLE 2

An antireflective member of Example 2 was obtained in the same manner as in Example 1 except that a high refractive index layer was formed between the hardcoat layer and the low refractive index layer. The high refractive index layer in Example 2 was formed as follows.

The coating solution for a high refractive index layer 1 was applied onto the hardcoat layer, and then dried at 70° C. for 1 minute to vaporize the solvent. Subsequently, by ultraviolet irradiation at a cumulative light amount of 50 mJ/cm² in a nitrogen atmosphere with an oxygen concentration of 200 ppm or less, a high refractive index layer having a dry film thickness of 100 nm was formed.

### Examples 3, 4, and 6 to 11

Antireflective members of Examples 3, 4, and 6 to 11 were obtained in the same manner as in Example 1 except that the coating solution with a number shown in Table 1 was used as the coating solution for a low refractive index layer, and the thickness of the low refractive index layer was set to a thickness shown in Table 1.

### EXAMPLE 5

An antireflective member of Example 5 was obtained in the same manner as in Example 2 except that the coating solution with a number shown in Table 1 was used as the coating solution for a low refractive index layer.

### Comparative Examples 1 to 6

Antireflective members of Comparative Examples 1 to 6 were obtained in the same manner as in Example 1 except that the coating solution with a number shown in Table 1 was used as the coating solution for a low refractive index layer.

In Table 1, the content rate with *1 means the content rate of the solid particles α based on the total solid content of the low refractive index layer, and the content rate with *2 means the content rate of the hollow particles based on the total solid content of the low refractive index layer.

TABLE 1

| | | Low refractive index layer | | | | | | | |
|---|---|---|---|---|---|---|---|---|---|
| | High | | Solid particles α | | Hollow particles | | | | Standard |
| | refractive | | Average | | Average | | | Average | deviation |
| | index layer | Number | particle | Content | particle | Content | | of numbers | of numbers |
| | Presence/ | of coating | size | rate *1 | size | rate *2 | Thickness | of solid | of solid |
| | Absence | solution | (nm) | (mass %) | (nm) | (mass %) | (nm) | particles α | particles α |
| Example 1 | Absence | 1 | 80 | 27.4 | 60 | 9.1 | 95 | 2.6 | 0.51 |
| Example 2 | Presence | 1 | 80 | 27.4 | 60 | 9.1 | 95 | 3.3 | 0.51 |
| Example 3 | Absence | 2 | 80 | 27.4 | 75 | 9.1 | 95 | 2.6 | 0.47 |
| Example 4 | Absence | 3 | 80 | 18.3 | 60 | 18.3 | 95 | 1.2 | 0.44 |
| Example 5 | Presence | 3 | 80 | 18.3 | 60 | 18.3 | 95 | 1.4 | 0.42 |
| Example 6 | Absence | 4 | 80 | 32.9 | 60 | 3.7 | 95 | 5.7 | 0.56 |
| Example 7 | Absence | 1 | 80 | 27.4 | 60 | 9.1 | 115 | 2.9 | 0.41 |
| Example 8 | Absence | 1 | 80 | 27.4 | 60 | 9.1 | 75 | 3.3 | 0.51 |
| Example 9 | Absence | 1 | 80 | 27.4 | 60 | 9.1 | 60 | 2.8 | 0.47 |
| Example 10 | Absence | 5 | 100 | 27.4 | 60 | 9.1 | 95 | 2.2 | 0.47 |
| Example 11 | Absence | 6 | 80 | 13.7 | 60 | 22.8 | 95 | 0.9 | 0.36 |
| Comparative | Absence | 7 | — | 0 | 60 | 9.1 | 95 | 0 | 0 |
| Example 1 | | | | | | | | | |
| Comparative | Absence | 8 | — | 0 | 60 | 9.1 | 95 | 0 | 0 |
| Example 2 | | | | | | | | | |
| Comparative | Absence | 9 | 80 | 9.1 | 60 | 27.4 | 95 | 0.5 | 0.28 |
| Example 3 | | | | | | | | | |
| Comparative | Absence | 10 | 80 | 9.1 | 75 | 27.4 | 95 | 0.4 | 0.30 |
| Example 4 | | | | | | | | | |
| Comparative | Absence | 11 | 80 | 4.6 | 60 | 31.9 | 95 | 0.4 | 0.30 |
| Example 1 | | | | | | | | | |
| Comparative | Absence | 12 | 80 | 50.0 | — | 0 | 95 | 9.2 | 0.86 |
| Example 6 | | | | | | | | | |

TABLE 2

| | Scratch resistance | | | | | | | |
|---|---|---|---|---|---|---|---|---|
| | Eraser resistance | | | | Optical properties | | | |
| | | Pure water | | | Reflectance | | Total light | |
| | | contact angle | | Steel wool | Y | SCE | transmittance | Haze |
| | ΔY | (degrees) | Evaluation | resistance | (%) | (%) | (%) | (%) |
| Example 1 | 0.3 | 99 | A | A | 1.9 | 0.21 | 93.5 | 0.9 |
| Example 2 | 0.4 | 100 | A | A | 0.8 | 0.29 | 93.7 | 1.0 |
| Example 3 | 0.3 | 97 | A | A | 1.7 | 0.22 | 93.6 | 1.0 |
| Example 4 | 0.2 | 97 | A | A | 1.5 | 0.20 | 93.6 | 0.9 |
| Example 5 | 0.5 | 99 | A | A | 0.6 | 0.25 | 93.9 | 1.1 |
| Example 6 | 0.2 | 100 | A | A | 2.6 | 0.26 | 93.3 | 1.1 |
| Example 7 | 0.1 | 100 | A | A | 2.4 | 0.24 | 93.3 | 0.9 |
| Example 8 | 0.1 | 99 | A | B | 2.1 | 0.27 | 93.4 | 1.2 |
| Example 9 | 0.1 | 102 | A | B | 2.5 | 0.57 | 93.3 | 1.6 |
| Example 10 | 0.3 | 98 | A | B | 1.5 | 0.99 | 93.1 | 2.3 |
| Example 11 | 0.7 | 90 | A | B | 1.3 | 0.20 | 93.6 | 1.0 |
| Comparative Example 1 | 1.5 | 61 | D | A | 2.0 | 0.15 | 93.5 | 0.9 |
| Comparative Example 2 | 0.3 | 79 | C | A | 1.9 | 0.17 | 93.5 | 0.9 |
| Comparative Example 3 | 0.4 | 76 | C | B | 1.2 | 0.18 | 93.6 | 1.0 |
| Comparative Example 4 | 1.7 | 62 | D | C | 0.8 | 0.22 | 93.7 | 1.2 |
| Comparative Example 5 | 0.5 | 72 | C | C | 1.0 | 0.18 | 93.6 | 1.1 |
| Comparative Example 6 | 1.3 | 62 | D | C | 2.5 | 0.32 | 93.4 | 1.7 |

From the results of Tables 1 and 2, it can be confirmed that the antireflective members of Examples can provide good scratch resistance.

### REFERENCE SIGNS LIST

10: substrate
20: hardcoat layer
30: low refractive index layer
100: antireflective member
110: display element
120: image display panel

1. An antireflective member comprising a low refractive index layer on a substrate, wherein
the low refractive index layer comprises a binder component, hollow particles, and solid particles,
the low refractive index layer comprises, as the solid particles, solid particles α having a particle size larger than an average particle size of the hollow particles, and
in an image of a perpendicular cross-section of the antireflective member taken with a scanning transmission electron microscope, an average of numbers of the solid particles ac per μm in a width direction of the low refractive index layer is in a range from 0.7 to 8.0.

2. The antireflective member according to claim 1, wherein the average particle size of the hollow particles is in a range from 40 nm and to 100 nm.

3. The antireflective member according to claim 1, wherein an average particle size of the solid particles ac is in a range from 50 nm to 150 nm.

4. The antireflective member according to claim 1, wherein, when a thickness of the low refractive index layer is defined as T and the average particle size of the hollow particles is defined as D1, a ratio D1/T is in a range from 0.2 to 1.7.

5. The antireflective member according to claim 1, wherein, when a thickness of the low refractive index layer is defined as T and an average particle size of the solid particles ac is defined as D2, a ratio D2/T is in a range from 0.3 to 2.5.

6. The antireflective member according to claim 1, wherein, when the average particle size of the hollow particles is defined as D1 and an average particle size of the solid particles ac is defined as D2, a ratio D2/D1 is in a range from 1.0 to 3.8 .

7. The antireflective member according to claim 1, wherein the hollow particles are hollow silica particles.

8. The antireflective member according to claim 1, wherein the solid particles c are solid silica particles.

9. The antireflective member according to claim 1, further comprising, as the solid particles, solid particles β having an average particle size smaller than or equal to the average particle size of the hollow particles.

10. The antireflective member according to claim 9, comprising, as the solid particles β, solid silica particles, solid alumina particles, solid titania particles, or solid zirconia particles, or a combination of a plurality of the particles therefrom.

11. The antireflective member according to claim 1, comprising, as the binder component, a cured product of polysilsesquioxane.

12. The antireflective member according to claim 1, comprising at least one functional layer present between the substrate and the low refractive index layer.

13. The antireflective member according to claim 12, comprising, as the functional layer, a hardcoat layer.

14. A polarizing plate comprising:
a polarizer,
a first transparent protective plate disposed on one side of the polarizer, and
a second transparent protective plate disposed on another side of the polarizer,
wherein the first transparent protective plate or the second transparent protective plate is the antireflective member according to claim 1, and
the antireflective member is disposed on the polarizer such that a side of the antireflective member opposite to the low refractive index layer faces the polarizer.

15. An image display panel comprising:
a display element, and
an optical film disposed on a light-emitting surface side of the display element,
wherein the image display panel comprises the antireflective member according to claim 1, as the optical film,
the antireflective member is disposed on the display element such that a a side of the antireflective member opposite to the low refractive index layer faces the display element, and
the antireflective member is disposed on an outermost surface of the image display panel.

16. An image display device comprising the image display panel according to claim 15, wherein the antireflective member is disposed on an outermost surface of the image display panel.

17. An antireflective article, comprising:
the antireflective member according to claim 1; and
a component,
wherein the antireflective member is disposed on the component such that a side of the antireflective member opposite to the low refractive index layer faces the component, and
the antireflective member is disposed on an outermost surface of the antireflective article.

18. A method for selecting an antireflective member, the method comprising:
determining whether or not each candidate for the antireflective member satisfies following (1) to (4) features; and
selecting one candidate for the antireflective member that satisfies the following (1) to (4) features:
(1) the antireflective member is an antireflective member comprising a low refractive index layer on a substrate;
(2) the low refractive index layer comprises a binder component, hollow particles, and solid particles;
(3) the low refractive index layer comprises, as the solid particles, solid particles α having a particle size larger than an average particle size of the hollow particles; and
(4) in an image of a perpendicular cross-section of the antireflective member taken with a scanning transmission electron microscope, an average of numbers of the solid particles ac per μm in a width direction of the low refractive index layer is in a range from 0.7 to 8.0.

19. The antireflective member according to claim 1, wherein the low refractive index layer has a refractive index in a range from 1.10 to 1.48.
